(19) United States
(12) Patent Application Publication
(10) Pub. No.: US 2002/0129125 A1
(43) Pub. Date: Sep. 12, 2002

(54) Network connection platform

(75) Inventor: Lonny Avital, Teaneck, NJ (US)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(73) Assignee: NTTX CORPORATION

(21) Appl. No.: 10/081,744

(22) Filed: Feb. 22, 2002

Related U.S. Application Data
(60) Provisional application No. 60/270,129, filed on Feb. 22, 2001.

(51) Int. Cl. G09G 5/00; G06F 15/16

(52) U.S. Cl. 709/219; 345/866

(57) ABSTRACT

A network connection platform receives a transaction from a remote device. In response to the transaction, the network connection platform generates a transaction request that causes at least one or more applications to run on a computing device. The network connection platform retrieves data from at least one application and transmits the data to the remote device.

### BACKGROUND OF THE INVENTION

1. Field of the Invention

The present invention relates to network communications. More particularly, the present invention relates to a platform for establishing a network connection between two or more devices.

2. Description of the Prior Art

Mobile computing devices are now widely available. They allow a user to carry various types of information outside of the normal work environment. Schedules, email, data files and even limited applications are now provided by these devices thus allowing a user to access and modify data remotely. Updating the modified information is usually accomplished by bringing the remote device to a desktop computer in the work environment and exchanging information over a local link such as a USB connection. However, when a user is away from the desktop computer, this local link is impossible to establish. In addition, when operating away from the desktop computer, it is usually not possible to retrieve information that has not previously been stored on the device. Another disadvantage of a remote device is that all applications available on the desktop computer are usually not available on the remote device. Also, the computing power of the remote device is limited due to size and portability requirements.

### SUMMARY OF THE INVENTION

It is an object of the present invention to provide a network connection between a computing device and a remote device.

It is another object of the present invention to allow the computing device and the remote device to exchange data over the network connection.

It is yet another object of the invention for the remote device to execute one or more applications on the computing device over the network connection.

It is a further object of the present invention for the computing device to store data in a storage area so that the remote device may access the data when the computing device is unavailable.

It is a still further object of the present invention to format the data being exchanged for display on a remote device that is wireless.

It is yet a further object of the present invention to provide a user with a set of pre-configured screens that may be customized and displayed on one or more remote devices to facilitate exchange of data and/or running of one or more applications.

It is yet another object of the present invention to provide the network connection between the computing device and the remote device over the Internet.

These and other objects and advantages of the present invention are achieved by a network connection platform that receives a transaction from a remote device. In response to the transaction, the network connection platform causes at least one of a plurality of applications to run on a computing device. The network connection platform retrieves data from the at least one application and transmits the data to the remote device.

### BRIEF DESCRIPTION OF THE DRAWINGS

FIG. 1 shows a diagram of a network connection platform in accordance with a preferred embodiment of the present invention;

FIG. 2 shows a customization window provided by a connection client for creating custom screens;

FIG. 3 shows a file menu of the customization window;

FIG. 4 shows a view menu of the customization window;

FIG. 5 shows a table editing window and a file menu for editing tables;

FIG. 6 shows a table and a table menu for editing tables;

FIG. 7 shows a session variables window for utilizing session variables in screens; and

FIG. 8 shows a block diagram of the connection server of FIG. 1.

### DETAILED DESCRIPTION OF THE INVENTION

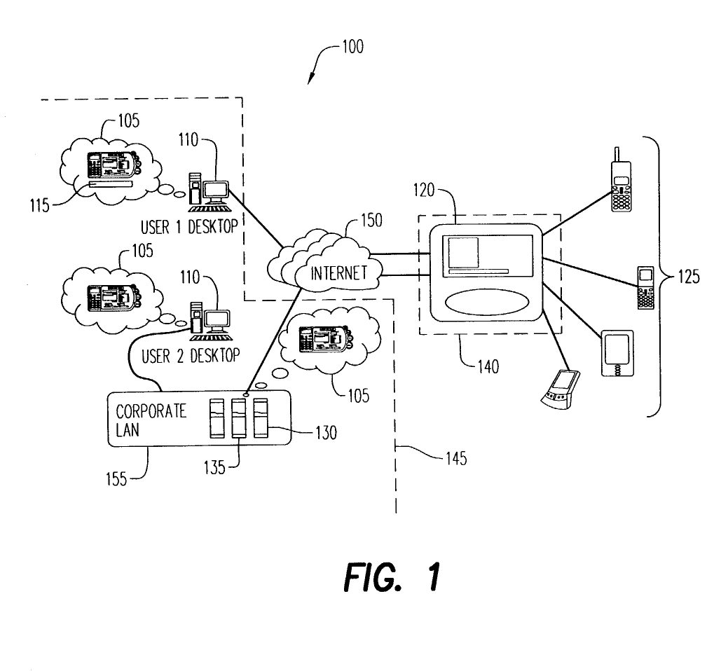

Referring to the figures, and, in particular, FIG. 1, there is provided a network connection platform of the present invention generally represented by reference numeral 100.

Network connection platform 100 includes a connection client 105, that typically resides on a computing device 110. Computing device 110 may be a desktop personal computer, a minicomputer or any other computing device suitable for use with the present invention. One or more computing devices 110 are typically located in a computing device environment 145. Examples of a computing device environment 145 include an office, a company, or any other environment where one or more computing devices may be located. Computing device environment may also include a corporate local area network (LAN) 155, a proxy server 130, and/or a central server 135.

Network connection platform 100 also includes a connection server 120 interposed between connection client 105 and one or more remote devices 125.

Connection client 105 is an application that enables a user of the computing device 110 to manage, edit and/or enhance the applications and data that may be accessed by one or more remote devices 125 through network connection platform 100. Connection client 105 allows the user of computing device 110 to create custom screens that will be displayed by the one or more remote devices 125. The screens are preferably presented together as a wireless homepage.

Upon installation, connection client 105 asks the user to provide default directory information, an identification number for use by the one or more remote devices 125 for logging in, and other initial information for setting up the custom screens.

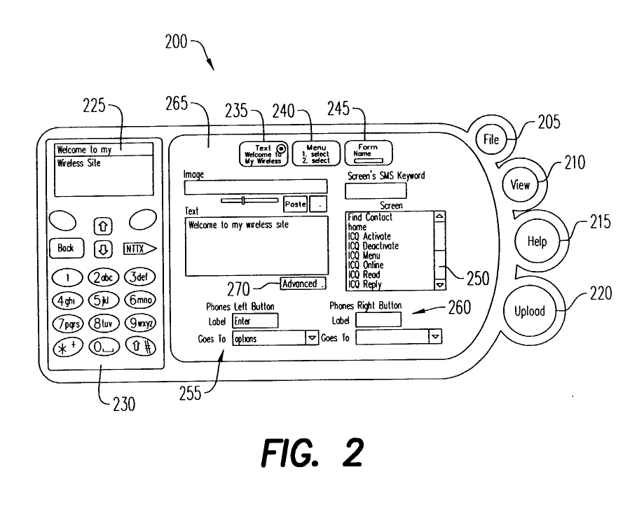

Once the initial information has been provided, a customization window 200 is presented to the user as shown in FIG. 2. Customization window 200 preferably has a “file” button 205, a “view” button 210, a “help” button 215, and an “upload” button 220. Customization window 200 also includes a display 225 and device buttons 230 that allow a user to see how the custom screens will appear and operate on the one or more remote devices 125. A “text” button 235 allows a text screen to be created, a “menu” button 240 allows a menu screen to be created, and a “form” button 245 allows a form screen to be created. A form screen is used to ask a user one or more questions and to save the responses.

Customization window 200 preferably has a screen menu 250 that is a menu of pre-configured screens that may be displayed on the one or more remote devices 125. In addition, a left button definition area 255 and a right button definition area 260 allow a user to specify labels for specific buttons on the one or more remote devices 125 and to specify screens that will be displayed if those buttons are activated. A main window 265 provides an area for inputting information to customize the pre-configured screens.

Each screen initially appears in a “simple” mode, that is a mode that is easy to use. Clicking on the “advanced” button 270 enables the use of more advanced features that are more complicated than “simple” mode. When in “advanced” mode, the nomenclature of button 270 changes to read “simple.” Clicking on button 270 again causes the screen to return to “simple” mode and button 270 to read “advanced.”

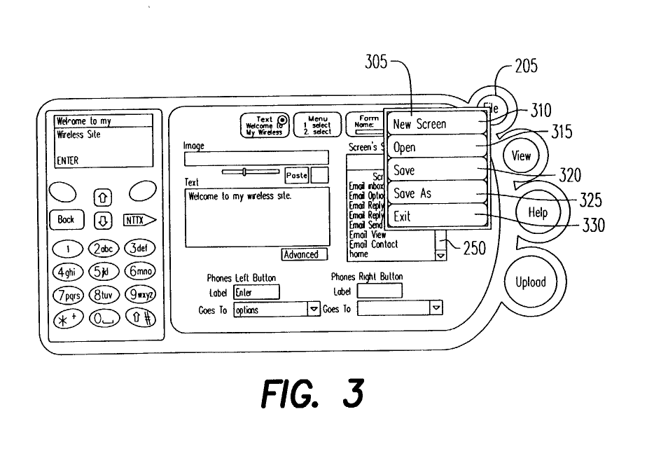

“File” button 205 is preferably activated by moving a cursor over the “file” button. Upon activation, a file menu 305 appears as shown in FIG. 3.

File menu 305 preferably has a “new screen” button 310 an “open” button 315, a “save” button 320, a “save as” button 325, and an “exit” button 330. “New screen” button 310 opens a new screen. “Open” button 315 opens an existing screen. An existing screen may also be opened by double-clicking on its name in screen menu 250 of FIG. 2. “Save” button 320 saves the currently open screen to the current location for that screen. “Save as” button 325 saves the currently open screen as a different filename or location as specified by the user. “Exit” button is used to exit connection client 105 as shown in FIG. 1.

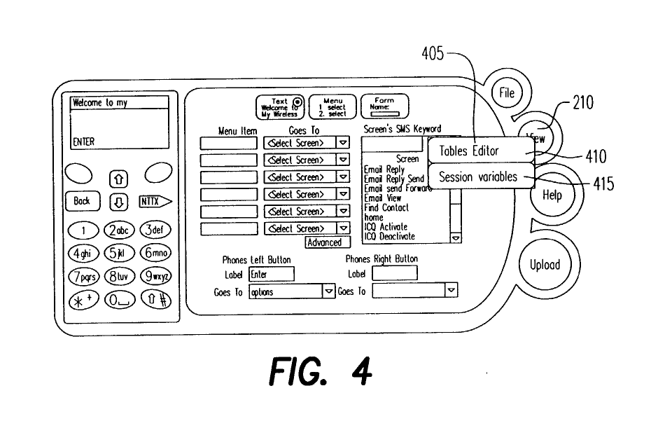

Referring to FIGS. 2 and 4, “view” button 210 is preferably activated by moving a cursor over the “view” button. Upon activation, a view menu 405 appears as shown in FIG. 4. View menu 405 preferably has a “tables editor” button 410 and a “session variables” button 415.

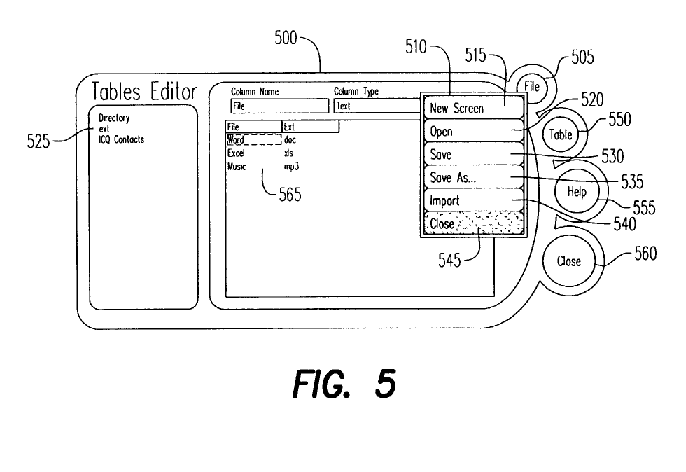

Activating “tables editor” button 410 brings up a table editor screen 500 as shown in FIG. 5. Table editor screen 500 has a “file” button 505, a “table” button 550, a “help” button 555, and a “close” button 560.

Activating “file” button 505 in table editing screen 500 displays a menu 510. A “new table” button 515 opens a new table. An “open button” 520 opens an existing table. An existing table may also be opened up by double-clicking on its name in the tables list 525. A “save” button 530 saves the currently open table 565 to the current location for the open table. A “save as” button 535 saves the currently open table 565 as a different filename or location as specified by the user. An “import” button 540 allows a user to import a table from an external file. A “close” button 545 closes the table editor screen 500.

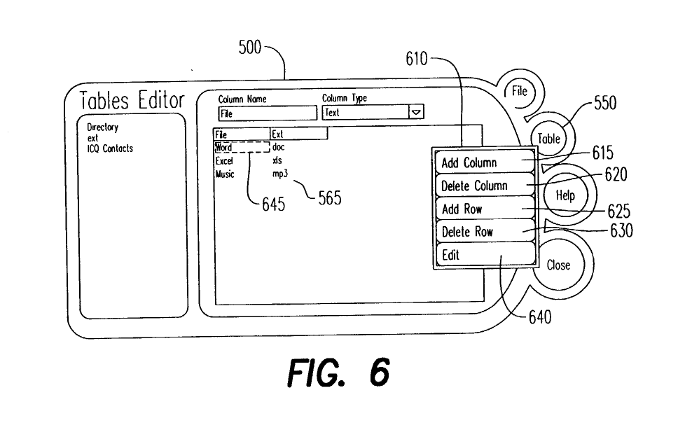

Activating “table” button 550 in table editing screen 500 displays a table editing menu 610 as shown in FIG. 6. An “add column” button 615 appends a column to the right of a selected column of currently open table 565. A “delete column” button 620 deletes a selected column from table 565. An “add row” button 625 adds a row to currently open table 565. A “delete row” button 630 deletes a selected row from table 565. An “edit” button allows a selected field 645 within table 565 to be edited. This may also be accomplished by double-clicking a field.

Table editor screen 500 may also provide other table editing tools that allow a user to change a column name, a column type (e.g., text, number, date, etc.), or display width. In addition, table editor screen 500 may provide the ability to move columns by “drag and drop” operations.

Returning to FIG. 5, activating “help” button 555 preferably displays a help file to provide the user with further information regarding editing tables. Activating “close” button 560 closes table editing screen 500.

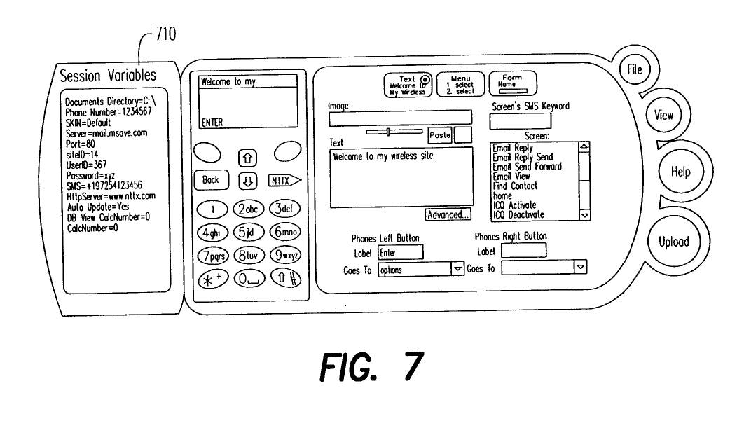

Turning to FIG. 4, activating “session variables” button 415 displays a session variables window 710 as shown in FIG. 7. Session variables window 710 shows the various inputs and selections made by the user while running the current session of the customization window 200 shown in FIG. 2. These inputs and selections, referred to as session variables, may be referenced and used in queries, input forms, text screens, etc.

Turning again to FIG. 2, when creation and customization of screens is complete, activating the “upload” button uploads the screens to connection server 120.

Returning to FIG. 1, one component of connection client 105 is a client transaction server 115. Client transaction server 115 typically resides in a startup folder of computing device 110, or is otherwise configured to run automatically when the computing device is started. Upon startup, client transaction server 115 establishes a communication path to a connection server 120. It is important to note that for security purposes, only connection client 105 can open a communication path to connection server 120. Client transaction server 115 executes transaction requests from connection server 120.

A transaction request may be a request for data or a request to run an application. A transaction request may also be a request to run an application available to computing device 110 with additional data included in the transaction request. For example, connection server 120 may send a request to view the contents of a folder on computing device 110. In response, client transaction server 115 executes a directory command and returns the results to the connection server 120. As another example, connection server 120 may send a request to run a billing application that is normally run from computing device 110, and that request may include data to be calculated by the billing application. In response to this request, client transaction server 115 causes the application to run with the included data and returns the results to connection server 120.

The data and/or applications that may be accessed by connection client 105 can include any type of data and/or application available through computing device 110. The data may also be accessed through various formats including one or more text files, databases, applications, COM objects, CORBA services, JAVA services, voice, videos, and streaming videos.

Client transaction server 115 also periodically checks connection server 120 for upgrades, and implements those upgrades on computing device 110. This allows for automatic updating of connection client 105, as well as the capability of implementing new services automatically. Client transaction server 115 also supports one or more connections through proxy server 130, as found, for example, in a corporate networked environment. Connection client 105 and client transaction server 115 may reside on central server 135 rather than on computing device 110. This may be advantageous in an organization that desires to create a standard set of data and applications for use over network connection platform 100.

A connection path between client transaction server 115 and connection server 120 is preferably implemented through the Internet 150.

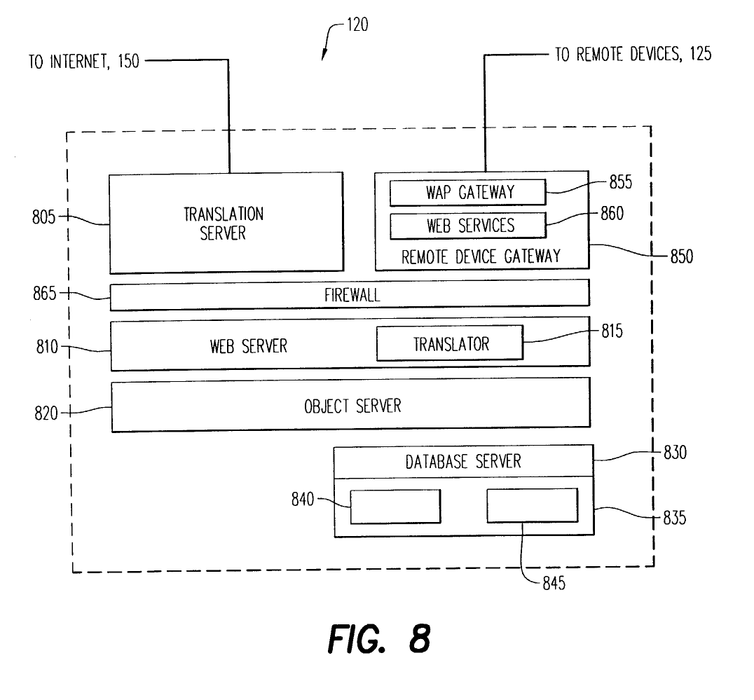

FIG. 8 shows the components of connection server 120. Connection server 120 acts as a gateway between one or more remote devices 125 and one or more computing devices 110.

Connection server 120 may be located within computing hardware dedicated to the operation of the connection server. In a preferred embodiment, connection server 120 is located in computing hardware that performs multiple functions, for example, an Internet service provider's facility 140 (as shown in FIG. 1).

Connection server 120 has a transaction server 805 that is capable of monitoring and managing communication paths from one or more connection clients 105. Transaction server 805 passes transactions requests and data back and forth between connection server 120 and one or more computing devices 110.

Connection server 120 has a remote device gateway 850 that manages communication paths between the one or more remote devices 125 and the connection server. Remote device gateway 850 may include a wireless applications protocol (WAP) gateway 855 for communicating with the one or more remote devices 125 that are wireless. If connection server 120 runs from Internet service provider's facility 140, remote device gateway 850 may also provide web services 860 from the Internet service provider's facility 140 shown in FIG. 1.

Connection server 120 preferably has a web server 810 that acts as an interface between transaction server 805 and remote device gateway 850. Web server 810 formats data received from transaction server 805 for display on one or more of the remote devices 125. Web server 810 also includes a translator 815 for formatting data to be displayed on the one or more remote devices 125 that are wireless.

For security purposes, a firewall 865 isolates web server 810 from transaction server 805 and remote device gateway 850.

An object server 820 manages the operation of connection server 120. Object server 820 analyzes communications from one or more remote device 125 and performs various operations in response. Upon a remote device 125 logging in, object server 820 presents remote device 125 with screens previously designed using connection client 105. As a user of remote device 125 navigates the screens and inputs data, the remote device generates various transactions including requests to retrieve data, run certain applications, and/or to run one or more applications with a particular set of data. In response to transactions generated by remote device 125 using the previously designed screens, object server 820 sends transaction requests to one or more computing devices 110. Examples of transaction requests include exchanging email, address book information, and schedule information between one or more computing devices 110 and one or more of the remote devices 125. Other transaction requests may include converting voice messages from one or more of the remote devices 125 to text, email, or sound files, and sending those files for processing to one or more computing devices 110.

When a computing device 110 responds to a transaction request, object server 820 in combination with web server 810 and remote device gateway 850 formats the response for delivery to one or more remote devices 125.

Object server 820 also supports transactions from remote devices 125 that include requests for information from locations on the Internet 150 such as web and FTP (file transfer protocol) sites. In addition, object server 820 manages connections to Internet relay chat servers, allowing remote devices to participate in “chat” exchanges.

Object server 820 also manages individual accounts associated with computing devices 110 and the one or more remote devices 125. Typical individual account information may include one or more passwords, addresses, telephone numbers, and billing and pricing information. Object server 820 also allows connection server 120 to deployed over different computers in a distributed fashion, and provides for general management of computer resources such as advanced thread pooling, built-in page caching, persistent queries, and database connection pooling. Object server 820 also includes computer resource load balancing and failure recovery mechanisms, as well as reporting and analysis tools.

Connection server 120 also includes a database server 830, for example an SQL server, to manage application data 840 and user data 845 that are stored in database 835. Application data 840 includes information such as screens previously designed using connection client 105, or other data related to applications delivered through connection server 120 to remote devices 125. User data 845 may include data from computing devices 110, stored on the connection server 120 in database 835, so that it may be available even when computing device 110 is not available.

The network connection platform 120 is described in the context of a hardware and software combination of clients, servers, and various support resources. However, it should be understood that that network connection platform 120 may be implemented solely in software or solely in hardware, or may be implemented in any combination of hardware and software suitable for providing the functions of the present invention.

It is also contemplated that the present invention may include a program storage device readable by a machine, tangibly embodying a program of instructions executable by the machine to perform a method of exchanging information between a remote device and a computing device.

Thus, while the present invention has been particularly shown and described with respect to preferred embodiments thereof, it will be understood by those skilled in the art that changes in form and details may be made therein without departing from the scope and spirit of the present invention.

We claim:

1. A method of exchanging information between a remote device and a computing device comprising:
receiving a transaction from the remote device;
generating a transaction request that causes at least one of a plurality of applications to run on the computing device in response to the transaction;
retrieving data from the at least one of said plurality of applications; and
transmitting the data to the remote device.

2. The method of claim 1, wherein said receiving a transaction from the remote device comprises:
transmitting a customized screen to the remote device; and
generating a transaction on the remote device in response to data input using the screen.

3. The method of claim 1, wherein said transmitting the data to the remote device comprises formatting the data for display by the remote device.

4. The method of claim 3, wherein formatting the data for display by the remote device comprises integrating the data into customized pre-configured screens for display by the remote device.

5. The method of claim 1, wherein the remote device is a wireless device.

6. The method of claim 1, wherein the computing device is a personal computer.

7. A method of exchanging information between a remote device and a computing device comprising:
providing a pre-configured screen for display on the remote device;
customizing the pre-configured screen for generating a transaction;
using the customized pre-configured screen on the remote device to generate the transaction;
running at least one of a plurality of applications in response to the transaction; and
transmitting data resulting from running the at least one of said plurality of applications to the remote device.

8. The method of claim 7, wherein said running at least one of said plurality of applications comprises:
transmitting the transaction from the remote device to a connection server;
generating a transaction request at the connection server in response to the transaction; and
receiving the transaction request.

9. The method of claim 8, wherein said receiving the transaction request comprises:
transmitting the transaction request from the connection server to a connection client; and
receiving the transaction request from the connection client.

10. The method of claim 7, wherein said transmitting data resulting from running the at least one of said plurality of applications to the remote device comprises:
transmitting the data to a connection server;
formatting the data at the connection server for presentation to the remote device; and
transmitting the formatted data to the remote device.

11. The method of claim 10, wherein said formatting the data at the connection server for presentation to the remote device comprises integrating the data into a pre-configured customized screen for display by the remote device.

12. The method of claim 7, wherein the remote device is a wireless device.

13. The method of claim 7, wherein the computing device is a personal computer.

14. A program storage device readable by a machine, tangibly embodying a program of instructions executable by the machine to perform a method of exchanging information between a remote device and a computing device, the method comprising:
receiving a transaction from the remote device;
generating a transaction request that causes at least one of a plurality of applications to run on the computing device in response to the transaction;
retrieving data from the at least one of said plurality of applications; and
transmitting the data to the remote device.

15. The program storage device of claim 14, wherein said receiving a transaction from the remote device comprises:
transmitting a customized screen to the remote device; and
generating the transaction on the remote device in response to data input using the screen.

16. The program storage device of claim 14, wherein said transmitting the data to the remote device comprises formatting the data for display by the remote device.

17. The program storage device of claim 16, wherein said formatting the data for display by the remote device comprises integrating the data into customized pre-configured screens for display by the remote device.

18. A program storage device readable by a machine, tangibly embodying a program of instructions executable by the machine to perform a method of exchanging information between a remote device and a computing device, the method comprising:
providing a pre-configured screen for display on the remote device;
customizing the pre-configured screen for generating a transaction;
using the customized pre-configured screen on the remote device to generate the transaction;
running at least one of a plurality of applications in response to the transaction; and
transmitting data resulting from running the at least one of said plurality of applications to the remote device.

19. The program storage device of claim 18, wherein said running at least one of said plurality of applications comprises:
transmitting the transaction from the remote device to a connection server;
generating a transaction request at the connection server in response to the transaction; and
receiving the transaction request.

20. The program storage device of claim 19, wherein said receiving the transaction request comprises:
transmitting the transaction request from the connection server to a connection client; and
receiving the transaction request from the connection client.

21. The program storage device of claim 18, wherein said transmitting data resulting from running the at least one of said plurality of applications to the remote device comprises:
transmitting the data to a connection server;
formatting the data at the connection server for presentation to the remote device; and
transmitting the formatted data to the remote device.

22. The program storage device of claim 21, wherein said formatting the data at the connection server for presentation to the remote device comprises integrating the data into a pre-configured customized screen for display by the remote device.
